(19) United States
(12) Patent Application Publication
(10) Pub. No.: US 2008/0030930 A1
(43) Pub. Date: Feb. 7, 2008

(54) Supply System for Low-Voltage Switchgear

(76) Inventors: Robert Adunka, Sulzbach-Rosenberg (DE); Georg Bollinger, Schwarzhofen (DE); Hans Brandl, Maxhutte-Haidhof (DE); Berthold Heldmann, Freudenberg (DE)

Correspondence Address: HARNESS, DICKEY & PIERCE, P.L.C., P.O.BOX 8910, RESTON, VA, 20195, US

(21) Appl. No.: 11/661,198

(22) PCT Filed: Aug. 16, 2005
(86) PCT No.: PCT/EP05/54014

§ 371 Date: Feb. 26, 2007

(30) Foreign Application Priority Data
Aug. 27, 2004 (EP) 04020469.5

(51) Int. Cl. H02B 1/20

(52) U.S. Cl. 361/611

(57) ABSTRACT

A supply system for low-voltage switchgear is disclosed, including an assembly device, for the assembly of at least one electromechanical switchgear, in an assembly plane, whereby the switchgear includes housing openings on at least one first side of the switchgear and at least one busbar, arranged such that the housing openings of the assembled switchgear essentially lie in the orthogonal direction to the assembly plane, between the busbar and the assembly plane. In at least one embodiment of the invention, a compact and secure supply system may be provided, whereby first device for keeping the housing openings clear are arranged between the busbar and the assembly plane.

### PRIORITY STATEMENT

This application is the national phase under 35 U.S.C. §371 of PCT International Application No. PCT/EP2005/054014 which has an International filing date of Aug. 16, 2005, which designated the United States of America and which claims priority on German Patent Application number 04020469.5 filed Aug. 27, 2004, the entire contents of which are hereby incorporated herein by reference.

### FIELD

Embodiments of the invention generally relate to a feed or supply system for low-voltage switching devices. Such systems may be used, for example, in switchgear cabinets in order to feed industrial loads, via electromechanical and electronic switching devices, from a power supply system.

### BACKGROUND

Known feed systems have a busbar system, which is connected to the power supply system and to which the switching devices are connected on the input side, and a mounting apparatus, which is used as a holder for the switching devices. Depending on the load or loads connected on the output side, circuit breakers for disconnecting short circuits, soft starters for motors, contactors for switching motors on and off, compact branches or overload relays are mounted on the mounting surface, for example. Furthermore, such a feed system also comprises, under certain circumstances, non-fused load branches.

If, in order to disconnect a short circuit, the contacts of a circuit breaker are opened, at first an arc is struck. In order to dissipate the hot, ionized gases produced in the process, the so-called plasma, from the housing, the circuit breaker has exhaust openings. In order to provide an unimpeded discharge of the plasma, it is necessary to ensure that the exhaust openings are always exposed. When mounting the circuit breakers it is therefore necessary to take care that the exhaust openings are not obstructed.

In order to achieve a packing density in the switchgear cabinets which is as high as possible, on the other hand, attempts are made to design the feed systems to be as compact as possible and to avoid long connection paths. For example, a feed system is known from WO 0062386 A1 in which the busbars are mounted directly on the circuit breakers, with the result that there is a very short connection path for the infeed (see FIG. 1). The exhaust openings of the circuit breakers in this system are, however, freely accessible and therefore, in principle, are capable of being obstructed.

FIG. 2 shows a so-called cage clamp feed system. This system is known from the product catalog “Siemens Calif. 01 2003” and, inter alia, provides the advantage that blocking of the exhaust openings is prevented by the design of the system. The feed system makes it possible to feed in and distribute energy for a group of a plurality of circuit breakers or complete load branches using cage clamp connection technology. The basis of the system includes a basic module having 3-phase busbars, which are connected to the power supply system.

The busbars are arranged beneath the mounted circuit breakers. In order to connect the circuit breakers on the input side to the busbars, connection webs are provided via which an electrical contact can be produced between the busbars and the circuit breakers by means of a connection plug. There is a free space between the connection webs and the upper side of the circuit breakers, on which upper side the exhaust openings are located, and this free space ensures that the plasma emerges unimpeded during disconnection. Owing to the selected arrangement, this free space is largely protected from becoming obstructed.

### SUMMARY

At least one embodiment the invention includes providing a compact and reliable feed system.

A feed system for low-voltage switching devices, in at least one embodiment, includes
a mounting apparatus for mounting at least one electromechanical switching device in a mounting plane, the switching device having housing openings on at least one first side of the switching device, and
at least one busbar, which is arranged such that, when a switching device is mounted, the housing openings and first means for keeping the housing openings free are located in the orthogonal direction with respect to the mounting plane essentially between the busbar and the mounting plane.

The arrangement according to at least one embodiment of the invention of the busbar(s) makes very short connection paths possible between the busbars and the feed contacts of the switching devices, since the busbars are mounted in the direct vicinity of these contacts. At the same time, the device(s) for keeping the housing openings free provides protection against the openings becoming obstructed. Furthermore, the device(s) prevents objects from being deposited intentionally or unintentionally on the first side of the switching devices and, as a result, blocking the housing openings.

In contrast to the cage clamp feed system, this advantage which is critical for operational reliability is not associated with a substantial increase in the physical height of the feed system, since, in the system according to at least one embodiment of the invention, the connection between the switching device and the busbar which is required for the infeed into the switching device is not routed over the side of the switching device with the housing openings.

The advantages of the feed system according to at least one embodiment of the invention come to bear in particular in an embodiment in which the mounting apparatus is provided for mounting at least one switching device in the form of an electromechanical circuit breaker and/or at least one switching device in the form of a combined switching device with a circuit-breaker functionality, the housing openings being provided as exhaust openings for blowing out a plasma produced in the event of a disconnection operation of the circuit breaker or of the compact branch. In this manner, the device(s) for keeping the housing openings free ensures that the plasma can escape unimpeded from the exhaust openings and therefore, for example, a phase short circuit is avoided.

The advantages of the use of the device(s) for keeping the housing openings free come to bear not only in switching devices having the functionality of a short-circuit current interruption such as the abovementioned circuit breakers and the combined switching devices with circuit breaker functionality, however. The device(s) for keeping the housing openings free also increase the operational reliability in at least one embodiment of the invention in which the mounting apparatus is provided for mounting a switching device in the form of a soft starter, the housing openings being in the form of aeration openings for the purpose of cooling the soft starter. In the event of the aeration openings becoming blocked, sufficient cooling of the soft starter would no longer be ensured. This blockage can be avoided by the device(s) for keeping the aeration openings free.

The operational reliability of a feed system having the features according to at least one embodiment of the invention can be further increased by the feed system having second device(s) for keeping further housing openings free, the further housing openings being arranged on a second side of the switching device which is opposite the first side of the switching device. The further exhaust openings are generally associated with the outgoing-side contacts of the switching device. The second device(s) for keeping further housing openings of the switching device free ensure that the outgoing-side housing openings can also not become obstructed to an impermissible extent. In a switching device used as a circuit breaker, the plasma igniting when a short-circuit current is disconnected can therefore escape unimpeded.

In a switching device in the form of a soft starter, the further housing openings are used, along with the housing openings fitted to the first side of the switching device, to ensure effective aeration of the soft starter.

Various embodiments are conceivable for the device(s) for keeping the housing openings free. For example, the first and/or the second device(s) for keeping the housing openings free can have a frame, which surrounds the housing openings and is arranged, substantially without a gap, on the first and/or the second side of the switching device.

Such an embodiment is particularly advantageous if the frame has partition walls, which are arranged such that they form channels, together with the frame and the housing openings, one channel being associated with each housing opening. In this case, the partition walls fulfill two tasks. Firstly, they form, together with the frame, a grid-like structure which largely prevents a blockage of the housing openings by them becoming obstructed and by even relatively small objects being deposited. Secondly, in a switching device in the form of a circuit breaker, the partition walls split the region directly above the housing openings acting as exhaust openings such that the plasma flows emerging from the individual exhaust openings in the event of a disconnection operation are separated from one another. This prevents a flashover between the plasma flows and a phase short, circuit associated therewith.

For the case in which objects are deposited on the frame fitted with partition walls, in the case of the circuit breaker it is also possible to ensure that gas produced by the arc being struck escapes towards a plurality of sides. Expediently, the partition walls and/or the frame have apertures for this purpose. Advantageously, these apertures are fitted in an uncritical region, i.e. above the region in which the arc burns. As a result, a phase short circuit through the apertures is avoided. Nevertheless, the gas can escape towards the apertures if the frame fitted with the partition walls is intended to be covered locally.

Alternatively, cutouts can also be provided in the partition walls which are provided on that edge of each partition wall which is remote from the first side of the switching device and/or on that edge of the frame which is remote from the first side of the switching device. The cutouts fulfill the same purpose as the apertures. Owing to the position of the cutouts defined here, the connection channel produced by the cutouts between the partition walls is also arranged in an uncritical region here.

In order to avoid a blockage of the exhaust openings even by way of relatively small objects, it is expedient that the first and/or the second device(s) for keeping the housing openings free have a fine-mesh structure for covering the housing openings on that side of the first and/or second device(s) for keeping the housing openings free which is remote from the housing openings. If, for example, the frame fitted with partition walls is used as the first and/or second device(s) for keeping the housing openings free, this frame can still be covered with a grating or a lamellar structure. This prevents very small parts, which could fall into the channels formed by the partition walls, from blocking the housing openings.

One embodiment of the first and/or second device(s) for obstructing the exhaust openings which is very simple in design terms can be achieved by the first and/or second device(s) for keeping the housing openings free having at least two bolts. In the simplest case, the first and/or second device(s) include exclusively these two bolts. These bolts delimit the housing openings arranged on one side of the switching device(s) and prevent them from becoming obstructed. Ideally, a fine-mesh structure, for example in the form of a grating, can be provided on that side of the bolts which is remote from the housing openings, which fine-mesh structure prevents the housing openings from becoming blocked, even by relatively small objects.

In one advantageous embodiment of at least one embodiment of the invention, the first device(s) for keeping the housing openings free are designed to be integral with a holder for the busbar. A frame structure is conceivable here, for example, the frame having a holding clip apparatus for accommodating insulated busbars. Alternatively, the frame can also be manufactured integrally with a busbar box in which the busbar(s) is/are accommodated.

### BRIEF DESCRIPTION OF THE DRAWINGS

The invention will be described and explained in more detail below with reference to the example embodiments illustrated in the figures, in which:

FIG. 1 shows an arrangement of switching devices in the form of circuit breakers and a busbar system,

FIG. 2 shows a cage clamp feed system,

FIG. 3 shows a feed system having a device for keeping housing openings free in the form of a frame having partition walls,

FIG. 4 shows a feed system having a device for keeping housing openings free which includes two bolts and a grating, and

FIG. 5 shows a feed system in which a device for keeping housing openings free which is in the form of a frame having partition walls is designed to be integral with a busbar box.

### DETAILED DESCRIPTION OF THE EXAMPLE EMBODIMENTS

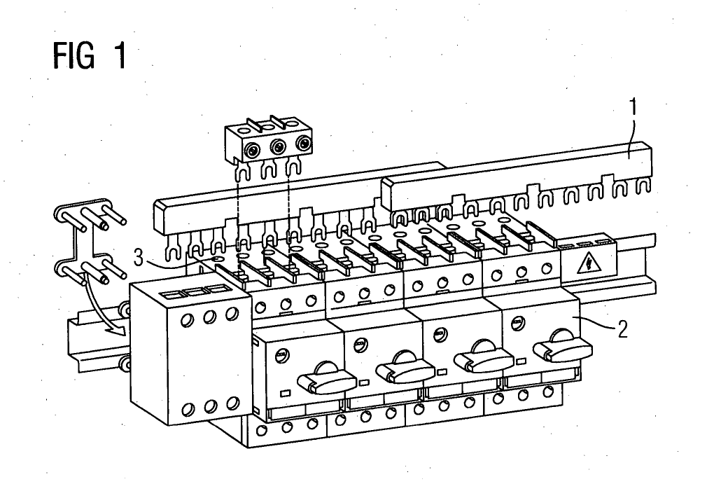

FIG. 1 shows an arrangement of switching devices 2 in the form of circuit breakers and a busbar system. In this system known from the prior art, the busbars 1 are fitted in front of the housing openings 3, which are provided as exhaust openings, of the circuit breakers 2, with the result that the exhaust openings 3 are exposed and the connection paths between the feed contacts of the circuit breakers 2 and the busbars 1 are minimal. With such an arrangement of the busbars 1, a very small physical height is achieved. When mounting in a switchgear cabinet, a very high packing density can therefore be achieved.

One disadvantage of the arrangement shown in FIG. 1 is the fact that the exhaust openings 3 are in no way protected against becoming obstructed in an impermissible manner. Furthermore, this arrangement cannot rule out the possibility of the exhaust openings 3 becoming blocked by intentionally or unintentionally deposited objects. If the exhaust openings 3 become blocked, phase short circuits can occur in the region of the connection terminals on the circuit breaker 2 and/or on adjacent devices owing to the plasma igniting during the disconnection process.

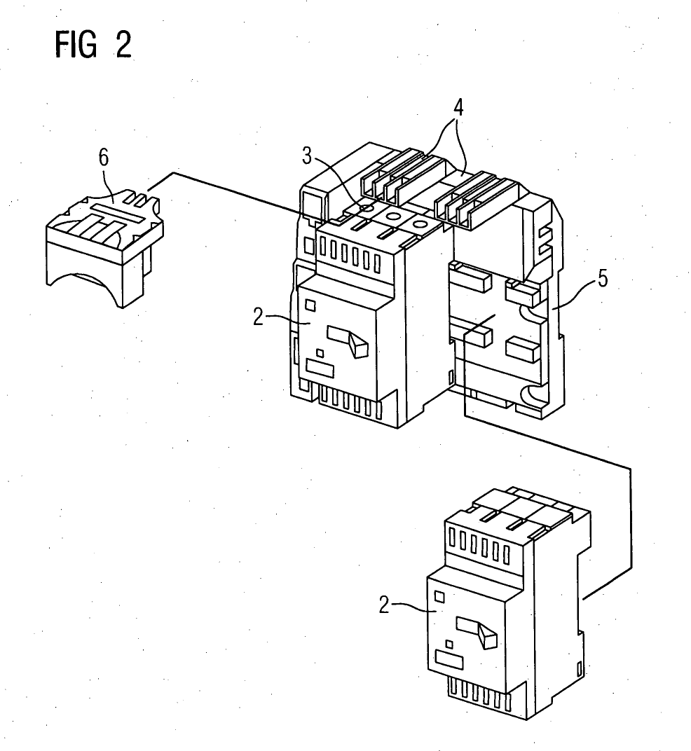

FIG. 2 shows a cage clamp feed system in which the abovementioned disadvantage of the exhaust openings 3 possibly becoming obstructed is avoided by a corresponding design. In the cage clamp feed system, the busbars are located behind the circuit breakers 2. For the infeed, the busbar potentials are made capable of being tapped off via the mounting surface 5 and connection webs 4 above the side of the circuit breaker 2 with the exhaust openings 3. The contact between the connection webs 4 and the feed contacts of the circuit breaker 2 is finally realized via a connection plug 6.

A sufficiently large gap is provided between the side of the circuit breaker 2 with the exhaust openings 3 and the connection webs 4 or connection plugs 6, and this gap ensures that the plasma is blown out unimpeded. Owing to the design measure, however, the physical height of the feed system is considerably increased.

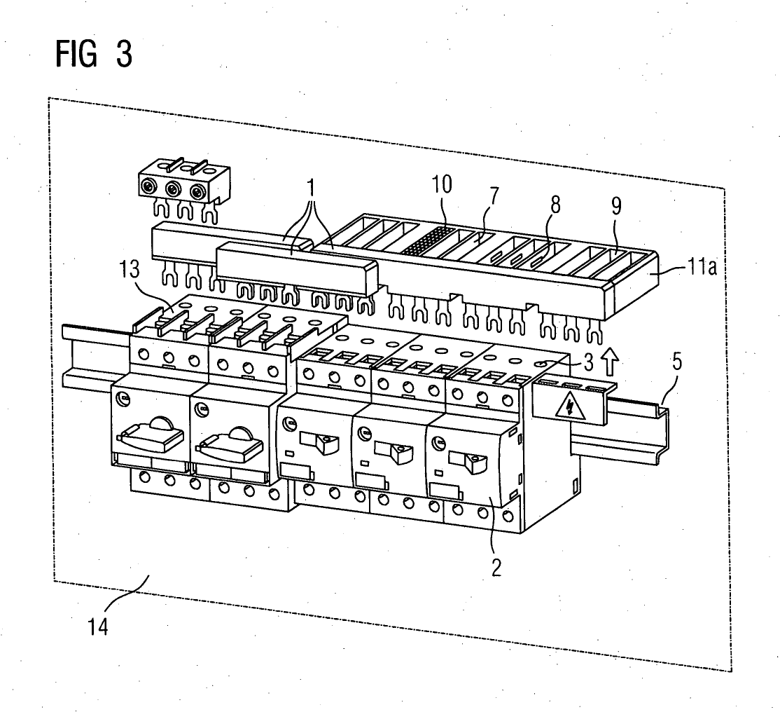

FIG. 3 shows a feed system having a device for keeping housing openings 3 free which is in the form of a frame 11a having partition walls 7. Switching devices 2 in the form of circuit breakers are fixed in a mounting plane 14 with a mounting apparatus 5 in the form of a top-hat rail. In the embodiment according to the invention which is illustrated here, the busbars 1 are located in the immediate vicinity of the feed contacts of the circuit breakers 2, with the result that long connection paths are avoided and a compact design of the entire feed system is ensured. At the same time, the housing openings 3 provided as exhaust openings are also protected against becoming blocked by the frame 11a and its partition walls 7. Owing to the frame 11a and the partition walls 7, channels 9 in the direction of the exhaust openings 3 are formed for each exhaust opening 3. The partition walls 7 therefore separate the plasma flows produced in the event of a disconnection from one another such that a phase short circuit via the exhausted plasma is prevented.

Furthermore, apertures 8 are provided in the partition walls 7 transversely with respect to the exhaust direction of the plasma. The apertures 8 are arranged so far removed from the exhaust openings 3 that a phase short circuit through the apertures 8 is ruled out.

On the other hand, the apertures 8 have the effect that, in the event of a blockage of individual channels 9, the gas produced when the arc is struck can still escape through the apertures 8 into adjacent channels 9 and from there upwards, with the result that an excess pressure is avoided and the arc is prevented from being forced back into the device, which is associated with this excess pressure. A similar functionality can be achieved if, in place of the apertures, cutouts are provided on that edge of the partition walls and of the frame which is remote from the circuit breakers.

The protective function of the frame 11a together with the partition walls 7 in terms of preventing a blockage of the exhaust openings 3 is improved further still by the individual channels 9 being covered by fine-mesh structures 10 in the form of gratings. The gratings 10 prevent the exhaust openings 3 from being blocked even by relatively small parts.

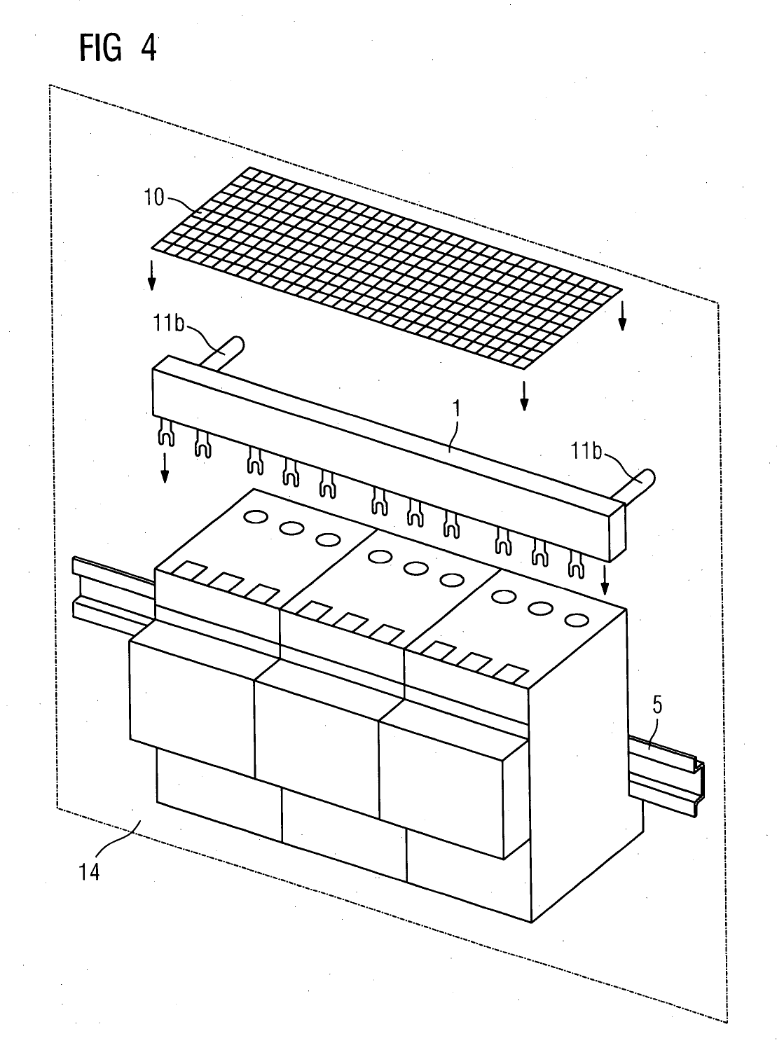

FIG. 4 shows an embodiment of the invention which can be realized in design terms in a particularly simple manner and in which a feed system is designed with a device for keeping housing openings free which includes two bolts 11b and a grating 10. A mechanical connection between the busbar 1 and the mounting plane 14 is produced via the bolts 11b. For example, the grating 10 can simply be placed onto the bolts 11b or connected to the busbar 1 or the mounting plane 14. Owing to the bolts 11b, a sufficient safety gap between the grating 10 and the housing openings 3 is provided.

In this embodiment, no additional separation of the plasma flows is provided, however, for the case in which the switching device is in the form of a circuit breaker.

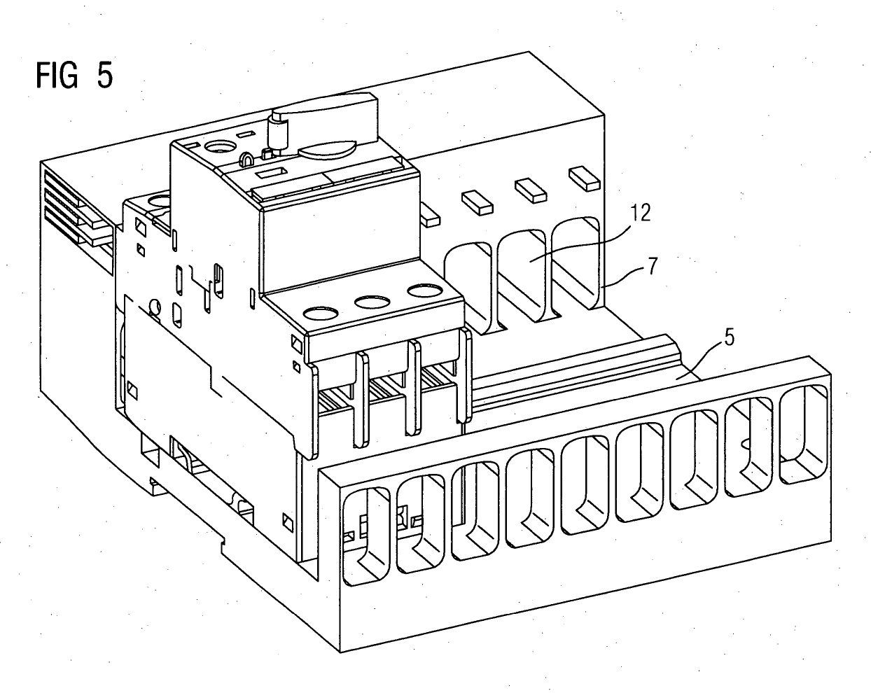

FIG. 5 shows a feed system in which a device for keeping housing openings free which is in the form of a frame having partition walls 7 is designed to be integral with a busbar box 12. In the embodiment illustrated, in addition the mounting apparatus 5 is also designed to be integral with the composite including the busbar box 12 and frame and its partition walls 7. This feed system, which is manufactured as an inseparable mechanical unit, provides maximum protection against any impermissible obstruction. The busbars arranged in the busbar box 12 are located in the direct vicinity of the feed contacts of the switching device, which provides a compact design for the feed system.

The present invention should not be restricted to the embodiments disclosed by way of example here. Instead, further embodiments are conceivable and are included by the invention as long as the basic concept is met that first device for keeping the housing openings free 11a, 11b are arranged on the first side of the switching device 2 between the busbar 1 and the mounting plane 14. In place of the grating 10 shown in FIG. 4, a closed surface may also be provided as long as it is arranged with a sufficiently large gap between it and the housing openings. In place of the bolts 11b, a plug-in connection is also conceivable which allows for the grating 10 to be mounted using the mounting apparatus 5. The corresponding means for producing such a plug-in connection can also be designed to be integral with the mounting apparatus 5, in a similar manner to the embodiment shown in FIG. 5. An integral design of the mounting apparatus and the frame for keeping the housing openings free is also conceivable, in which case a busbar box is fixed to the frame for example via a plug-in connection.

The embodiment shown in FIG. 4 can likewise be combined with a structure comprising partition walls which is let into the structure formed from the bolts 11b and the busbar 1 and therefore also provides separation of the plasma flows. Such an embodiment can be designed both with and without the grating 10 provided for covering purposes. The means illustrated for keeping the housing openings 3 free can furthermore also be provided on both sides of the circuit breaker 2 in order to protect the housing openings from becoming obstructed both on the incoming and outgoing side. The feed system is not provided exclusively for feeding circuit breakers. Instead, various other switching devices or branches can be located on the mounting surface, in particular even between the circuit breakers, such as soft starters for motors, contactors for connecting and disconnecting motors, overload relays or non-fused load branches, for example.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A feed system for low-voltage switching devices, comprising:
a mounting apparatus for mounting at least one electromechanical switching device in a mounting plane, the switching device including housing openings on at least one first side of the switching device; and
at least one busbar, arranged such that, when a switching device is mounted, the housing openings and first means for keeping the housing openings free are located in an orthogonal direction with respect to the mounting plane, essentially between the busbar and the mounting plane.

2. The feed system as claimed in claim 1, wherein the mounting apparatus is provided for mounting at least one switching device in the form of at least one of an electromechanical circuit breaker and a combined switching device with a circuit-breaker functionality, the housing openings being provided as exhaust openings for blowing out a plasma produced in the event of a disconnection operation of at least one of the circuit breaker and the compact branch.

3. The feed system as claimed in claim 1, wherein the mounting apparatus is provided for mounting a switching device in the form of a soft starter, the housing openings being in the form of aeration openings for cooling the soft starter.

4. The feed system as claimed in claim 1, wherein the feed system includes second means for keeping further housing openings free, the further housing openings being arranged on a second side of the switching device, opposite the first side of the switching device.

5. The feed system as claimed in claim 1, wherein, the first means for keeping the housing openings free includes a frame, which surrounds the housing openings and is arranged, substantially without a gap, on at least one of the first and second side of the switching device.

6. The feed system as claimed in claim 1, wherein, the frame includes partition walls, arranged such that they form channels, together with the frame and the housing openings, one channel being associated with each housing opening.

7. The feed system as claimed in claim 6, wherein at least one of, the partition walls and the frame includes apertures.

8. The feed system as claimed in claim 1, wherein, the first means for keeping the housing openings free includes a fine-mesh structure for covering the housing openings on that side of the first means for keeping the housing openings free which is remote from the housing openings.

9. The feed system as claimed in claim 4, wherein at least one of the first and the second means for keeping the housing openings free include at least two bolts.

10. The feed system as claimed in claim 1, wherein, the first means for keeping the housing openings free is designed to be integral with a holder for the busbar.

11. The feed system as claimed in claim 2, wherein the mounting apparatus is provided for mounting a switching device in the form of a soft starter, the housing openings being in the form of aeration openings for the purpose of cooling the soft starter.

12. The feed system as claimed in claim 4, wherein at least one of the first and second means for keeping the housing openings free includes a frame, which surrounds the housing openings and is arranged, substantially without a gap, on at least one of the first and second side of the switching device.

13. The feed system as claimed in claim 4, wherein at least one of the first and second means for keeping the housing openings free includes a fine-mesh structure for covering the housing openings on that side of at least one of the first and second means for keeping the housing openings free which is remote from the housing openings.

14. A feed system for low-voltage switching devices, comprising:
a mounting apparatus to mount at least one electromechanical switching device in a mounting plane, the switching device including housing openings on at least one first side of the switching device; and
at least one busbar, wherein, when a switching device is mounted, the housing openings and a first device, to keep the housing openings free, are located in an orthogonal direction with respect to the mounting plane, essentially between the busbar and the mounting plane.

15. The feed system as claimed in claim 14, wherein the mounting apparatus is provided to mount at least one switching device in the form of at least one of an electromechanical circuit breaker and a combined switching device with a circuit-breaker functionality, the housing openings being provided as exhaust openings to blow out a plasma produced in the event of a disconnection operation of at least one of the circuit breaker and the compact branch.

16. The feed system as claimed in claim 14, wherein the mounting apparatus is provided to mount a switching device in the form of a soft starter, the housing openings being in the form of aeration openings to cool the soft starter.

17. The feed system as claimed in claim 14, wherein the feed system includes a second device to keep further housing openings free, the further housing openings being arranged on a second side of the switching device, opposite the first side of the switching device.

18. The feed system as claimed in claim 14, wherein the first device to keep the housing openings free includes a frame, which surrounds the housing openings and is arranged, substantially without a gap, on at least one of the first and second side of the switching device.

19. The feed system as claimed in claim 17, wherein at least one of the first and second devices to keep the housing openings free includes a frame, which surrounds the housing openings and is arranged, substantially without a gap, on at least one of the first and second side of the switching device.

20. The feed system as claimed in claim 17, wherein at least one of the first and second devices to keep the housing openings free includes a fine-mesh structure for covering the housing openings on that side of at least one of the first and second means for keeping the housing openings free which is remote from the housing openings.
